(19) United States
(12) Patent Application Publication
(10) Pub. No.: US 2021/0262367 A1
(43) Pub. Date: Aug. 26, 2021

(54) Intake Valve Device Capable of Implementing Two-Stage Switching of Gas Distribution Phase and Diesel Engine

(71) Applicant: WEICHAI POWER CO., LTD., Weifang, Shandon (CN)

(72) Inventors: Demin JIA, Weifang (CN); Weitao DONG, Weifang (CN); Zhijie LI, Weifang (CN); Xiaoyan WANG, Weifang (CN); Dong LI, Weifang (CN)

(21) Appl. No.: 17/255,300

(22) PCT Filed: Sep. 4, 2018
(86) PCT No.: PCT/CN2018/103891

§ 371 Date: Dec. 22, 2020

(30) Foreign Application Priority Data
Jun. 28, 2018 (CN) 201810684681.6
Jun. 28, 2018 (CN) 201821014210.6

(51) Int. Cl. F01L 1/26; F01L 1/047; F01L 1/18; F01L 9/10; F01L 1/14; F01L 1/22

(52) U.S. Cl. CPC F01L 1/267; F01L 1/047; F01L 1/22; F01L 9/10; F01L 1/14; F01L 1/18

(57) ABSTRACT

An intake valve device capable of implementing two-stage switching of a gas distribution phase and a diesel engine. The intake valve device comprises a cam (1), a tappet guide rod component (2), a rocker arm (3), a variable valve bridge (7), and an intake valve (12) connected in sequence, and further comprises an intake valve drive piston (5), the intake valve drive piston (5) being capable of abutting against the rocker arm (3), a piston cavity accommodating the intake valve drive piston (5) is provided in the variable valve bridge (7), wherein communication between the high-pressure end of the piston cavity and a main oil path (10) can be established or broken by means of a high-pressure oil path (8), while the low-pressure end of the piston cavity is communicated with the main oil path (10) by means of a low-pressure oil path (11), and in order to ensure the formation of the pressure in the piston cavity to ensure that there is sufficient pressure to open the intake valve (12), an one-way valve (7) communicating from the low-pressure end to the high-pressure end is formed in the piston cavity. The cam (1) is a multi-lift cam having high and low cam molded lines, and can meet the requirements for the gas distribution phase under two working conditions, thereby achieving optimal engine performance and emission target. Moreover, the provided intake valve drive piston (5) and hydraulic oil path implement switching of the lifts of the cam (1).

This application claims the benefit of priorities to the following two Chinese patent applications, both of which are incorporated herein by reference,
1) Chinese Patent Application No. 201810684681.6, titled “INTAKE VALVE DEVICE CAPABLE OF IMPLEMENTING TWO-STAGE SWITCHING OF GAS DISTRIBUTION PHASE AND DIESEL ENGINE”, filed with the China National Intellectual Property Administration on Jun. 28, 2018; and
2) Chinese Patent Application No. 201821014210.6, titled “INTAKE VALVE DEVICE CAPABLE OF IMPLEMENTING TWO-STAGE SWITCHING OF GAS DISTRIBUTION PHASE AND DIESEL ENGINE”, filed with the China National Intellectual Property Administration on Jun. 28, 2018.

### FIELD

The present application relates to the technical field of diesel engines, and in particular to an intake valve device capable of implementing two-stage switch of valve timing and a diesel engine.

### BACKGROUND

Due to the deterioration of the environment and the impact of greenhouse effect, people are paying more and more attention to the emission of carbon dioxide while paying attention to the emission of pollutants from conventional diesel engines, which needs to control more variables in the process of upgrading the diesel engines.

A gas distribution mechanism is a main device of an intake system of the diesel engine, which mainly functions to regularly open and close intake and exhaust valves of each cylinder according to the requirements of the working sequence and working cycle of the engine, so as to allow fresh gas to enter the cylinder and exhaust gas to be discharged from the cylinder. The flexible control of the amount of intake gas and the valve timing by the gas distribution mechanism is related to the performance and emission index of the diesel engine.

However, at present, fixed valve timing is widely used in the diesel engines, that is, the valve timing is unchanging under full load and full working conditions, which is not conducive to implement the flexible control of the intake system and the optimal performance of the diesel engine under all working conditions.

Therefore, a technical issue to be addressed presently by those skilled in the art is to provide an intake valve device capable of implementing two-stage switch of valve timing, so as to implement switch of valve timing and improve the performance of the diesel engine.

### SUMMARY

In view of this, an intake valve device capable of implementing two-stage switch of valve timing is provided according to the present application, so as to implement switch of valve timing and improve the performance of diesel engines. A diesel engine having the intake valve device capable of implementing two-stage switch of valve timing is further provided according to the present application.

In order to achieve the above objects, the following technical solutions are provided according to the present application.

An intake valve device capable of implementing two-stage switch of valve timing includes a cam, a tappet-and-guide-rod component, a rocker arm, a variable valve bridge and an intake valve, which are connected in sequence, and further includes an intake valve drive piston capable of abutting against the rocker arm, wherein a piston cavity for accommodating the intake valve drive piston is arranged in the variable valve bridge, a high-pressure portion of the piston cavity may be communicated with a main oil path through a high-pressure oil path or be cut off from the main oil path, a low-pressure portion of the piston cavity is communicated with the main oil path through a low-pressure oil path, a one-way valve is arranged between the high-pressure portion and the low-pressure portion, and the one-way valve is unobstructed from the low-pressure portion to the high-pressure portion; and the cam is a multi-lift cam having high and low cam profiles.

Preferably, in the intake valve device, the intake valve device further includes a control valve configured to control the communication and non-communication between the high-pressure oil path and the main oil path.

Preferably, in the intake valve device, the control valve is a solenoid electric valve.

Preferably, in the intake valve device, the tappet-and-guide-rod component is connected with the rocker arm through a clearance adjusting bolt capable of adjusting a valve clearance.

Preferably, in the intake valve device, a reset spring configured to reset the intake valve drive piston is arranged in the piston cavity.

A diesel engine includes an intake valve device capable of implementing two-stage switch of valve timing, wherein the intake valve device capable of implementing two-stage switch of valve timing is the intake valve device capable of implementing two-stage switch of valve timing according to any one of the above aspects.

It can be seen from the above technical solutions that, the intake valve device capable of implementing two-stage switch of valve timing according to the present application includes the cam, the tappet-and-guide-rod component, the rocker arm, the variable valve bridge and the intake valve, which are connected in sequence, and further includes the intake valve drive piston. The intake valve drive piston is capable of abutting against the rocker arm. The piston cavity configured to accommodate the intake valve drive piston is arranged in the variable valve bridge. The high-pressure portion of the piston cavity may be communicated with the main oil path through the high-pressure oil path or be cut off from the main oil path. The low-pressure portion of the piston cavity is communicated with the main oil path through the low-pressure oil path. In order to ensure the formation of pressure in the piston cavity to ensure that sufficient pressure is provided to open the intake valve, the one-way valve unobstructed from the low-pressure portion to the high-pressure portion is provided in the piston cavity. The cam in the present application is a multi-lift cam having high and low cam profiles, which is able to simultaneously meet the requirements of two different working conditions on valve timing and implement the optimization of the engine performance and the emission target. The switch of the cam lift is implemented by the intake valve drive piston and the hydraulic oil paths.

### BRIEF DESCRIPTION OF THE DRAWINGS

For more clearly illustrating embodiments of the present disclosure or the technical solutions in the conventional technology, drawings referred to for describing the embodiments or the conventional technology will be briefly described hereinafter. Apparently, drawings in the following description are only examples of the present disclosure, and for the person skilled in the art, other drawings may be obtained based on the provided drawings without any creative efforts.

FIG. 1 is a schematic structural view of an intake valve device capable of implementing two-stage switch of valve timing according to an embodiment of the present application;

FIG. 2 is a data graph showing a first lift of the intake valve device according to an embodiment of the present application;

FIG. 3 is a data graph showing a second lift of the intake valve device according to an embodiment of the present application; and

FIG. 4 is a schematic structural view of a cam of the intake valve device capable of implementing two-stage switch of valve timing according to an embodiment of the present application.

### DETAILED DESCRIPTION OF THE EMBODIMENTS

A core of the present application is to provide an intake valve device capable of implementing two-stage switch of valve timing, so as to implement switch of valve timing and improve the performance of diesel engines. Another core of the present application is to provide a diesel engine having the intake valve device capable of implementing two-stage switch of valve timing.

The technical solutions according to the embodiments of the present application will be described clearly and completely as follows in conjunction with the drawings in the embodiments of the present application. It is apparent that the described embodiments are only a part of the embodiments according to the present application, rather than all of the embodiments. Based on the embodiments of the present application, all other embodiments obtained without creative efforts by those of ordinary skill in the art shall fall within the protection scope of the present application.

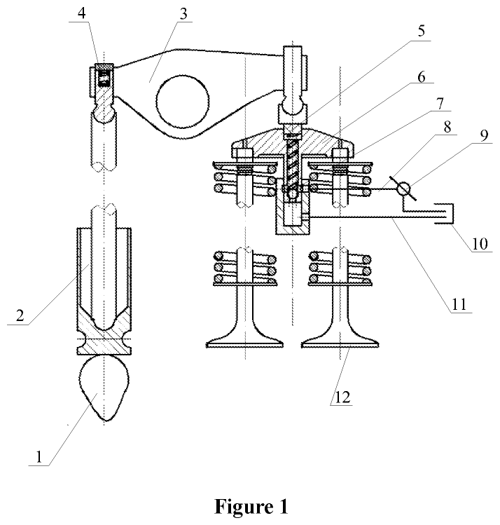

As shown in FIGS. 1 to 4, an intake valve device capable of implementing two-stage switch of valve timing is provided according to the present application, which includes a cam 1, a tappet-and-guide-rod component 2, a rocker arm 3, a variable valve bridge 6 and an intake valve 12, which are connected in sequence, and further includes an intake valve drive piston 5. The intake valve drive piston 5 is capable of abutting against the rocker arm 3. A piston cavity configured to accommodate the intake valve drive piston 5 is arranged in the variable valve bridge 6. A high-pressure portion of the piston cavity may be communicated with a main oil path 10 through a high-pressure oil path 8 or be cut off from the main oil path 10. A low-pressure portion of the piston cavity is communicated with the main oil path 10 through a low-pressure oil path 11. In order to ensure the formation of pressure in the piston cavity to ensure that sufficient pressure is provided to open the intake valve, a one-way valve 7 unobstructed from the low-pressure portion to the high-pressure portion is provided in the piston cavity. The cam 1 in the present application is a multi-lift cam having high and low cam profiles, which is able to simultaneously meet the requirements of two different working conditions on valve timing and implement the optimization of the engine performance and the emission target. The lift switch of the cam 1 is implemented by the intake valve drive piston 5 and the hydraulic oil paths.

In order to control the communication and non-communication between the high-pressure oil path 8 and the main oil path 10, the intake valve device according to the present application further includes a control valve 9, and the control valve 9 is arranged between the high-pressure oil path 8 and the main oil path 10. Specifically, the control valve 9 is a solenoid electric valve, which may also be a manual control valve in practice. It can be ensured that the switch is fast and accurate by adopting the solenoid electric valve as a control device and adopting the pressure of the lubricating oil of the diesel engine as a driving force source.

In a preferred embodiment, the tappet-and-guide-rod component 2 is connected with the rocker arm 3 through a clearance adjusting bolt 4 capable of adjusting a valve clearance. The position of the rocker arm 3 is adjustable through the clearance adjusting bolt 4, thereby adjusting the clearance of the intake valve.

The following is the control process of the intake valve device in the present application.

Firstly, the valve clearance is adjusted. In order to realize a predetermined function of the intake valve device, the valve clearance needs to be adjusted first. A feeler gauge with a certain thickness (the thickness needs to be determined according to a low lift of the cam, and the lift of the cam may be selected according to different needs) is placed between the variable valve bridge 6 and the rocker arm 3 shown in FIG. 1, and the clearance adjusting bolt 4 is adjusted until there is no valve clearance, and then the feeler gauge is taken out. Under the action of the reset spring, a certain valve clearance exists at the piston cavity.

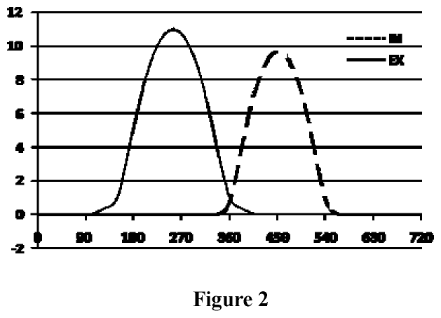

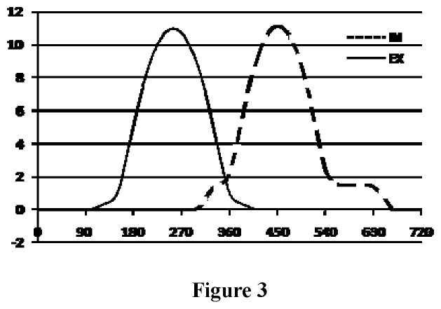

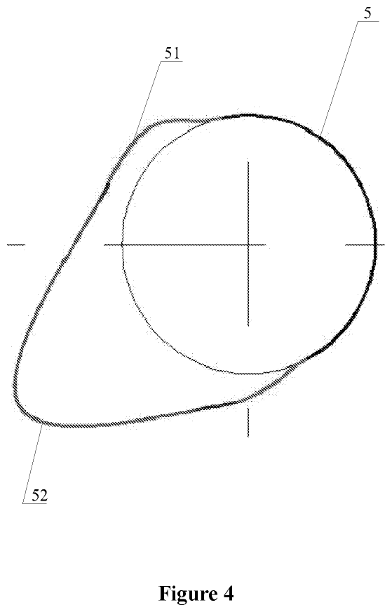

When the engine needs to operate with a normal valve lift, the control valve 9 is in an open state, and at this time, both the high-pressure oil path 8 and the low-pressure oil path 11 are in communication with the main oil path 10, the pressure of the high-pressure oil path is the same as the pressure of the low-pressure oil path, and the pressure under the intake valve drive piston 5 is insufficient to meet the requirement of opening the valve. As shown in FIG. 3, a low lift profile 51 of the cam is offset by the clearance, and the actual lift of the valve is shown as a dashed curve in FIG. 2. The low lift profile 51 of the cam in the present application is a section close to a center of a circle in FIG. 4, and the high lift profile 52 is a section away from the center of the circle in FIG. 4.

When the engine needs to be switched to a Miller valve lift, the control valve 9 is in a closed state, the high-pressure oil path 8 is cut off from the low-pressure oil path 11 under the action of the one-way valve 7, and the high-pressure oil path 8 is cut off from the main oil path 10 under the action of the control valve 9, and the pressure of the high-pressure oil path 8 gradually increases with the push of the rocker arm, that is, under the pressure of the intake valve drive piston 5, the low lift profile 51 of the cam works as shown in FIG. 4, and the actual lift of the valve is shown as the dashed curve in FIG. 3.

In practice, the multi-lift cam in the present application may have a symmetrical structure. In addition, the multi-lift cam may have an asymmetrical structure according to different needs. The core of the application is that the cam 1 has two lifts during the rotation.

In order to realize the reset of the intake valve drive piston 5, a reset spring configured to reset the intake valve drive piston 5 is arranged in the piston cavity.

In the present application, the control device for adjusting the cam lift is a pure hydraulic device, which has a simple and compact structure and only needs minor changes to the engine. The control device directly uses the lubricating oil of the engine as a pressure source, and no additional auxiliary device is needed. In the control device, the solenoid electric valve is adopted, which has a fast and accurate response, and can realize the accurate switch of different valve lifts.

In addition, a diesel engine is further disclosed according to the present application, which includes an intake valve device capable of implementing two-stage switch of valve timing, and the intake valve device capable of implementing the two-stage switch of valve timing is the intake valve device capable of implementing two-stage switch of valve timing disclosed in the above embodiments. Therefore, the diesel engine having the intake valve device capable of implementing two-stage switch of valve timing also has all of the technical effects described above, which will not be repeated here.

The above embodiments are described in a progressive manner. Each of the embodiments is mainly focused on describing its differences from other embodiments, and reference may be made among these embodiments with respect to the same or similar parts.

The above illustration of the disclosed embodiments can enable those skilled in the art to implement or use the present application. Various modifications to the embodiments are apparent to the person skilled in the art, and the general principle herein can be implemented in other embodiments without departing from the spirit or scope of the present application. Therefore, the present application is not limited to the embodiments described herein, but should be in accordance with the broadest scope consistent with the principle and novel features disclosed herein.

1. An intake valve device capable of implementing two-stage switch of valve timing, comprising:
a cam, a tappet-and-guide-rod component, a rocker arm, a variable valve bridge and an intake valve, which are connected in sequence, and further comprising an intake valve drive piston, capable of abutting against the rocker arm,
wherein a piston cavity for accommodating the intake valve drive piston is arranged in the variable valve bridge, a high-pressure portion of the piston cavity is communicated with a main oil path through a high-pressure oil path or is cut off from the main oil path, a low-pressure portion of the piston cavity is communicated with the main oil path through a low-pressure oil path, a one-way valve is arranged between the high-pressure portion and the low-pressure portion, and the one-way valve is unobstructed from the low-pressure portion to the high-pressure portion; and
the cam is a multi-lift cam having high and low cam profiles.

2. The intake valve device according to claim 1, further comprising a control valve configured to control communication and non-communication between the high-pressure oil path and the main oil path.

3. The intake valve device according to claim 2, wherein the control valve is a solenoid electric valve.

4. The intake valve device according to claim 1, wherein the tappet-and-guide-rod component is connected with the rocker arm through a clearance adjusting bolt capable of adjusting a valve clearance.

5. The intake valve device according to claim 1, wherein a reset spring configured to reset the intake valve drive piston is arranged in the piston cavity.

6. A diesel engine comprising an intake valve device capable of implementing two-stage switch of valve timing, wherein the intake valve device capable of implementing two-stage switch of valve timing is the intake valve device capable of implementing two-stage switch of valve timing according to claim 1.
